(19) United States
(12) Patent Application Publication
(10) Pub. No.: US 2025/0282587 A1
(43) Pub. Date: Sep. 11, 2025

(54) PALLET MOVER

(71) Applicant: Ocado Innovation Limited, Hatfield (GB)

(72) Inventors: Oliver Frederick KIRKBY, Hatfield (GB); Leslie WYNN, Hatfield (GB); Gaurav Mehta, Hatfield (GB)

(21) Appl. No.: 19/217,433

(22) Filed: May 23, 2025

Related U.S. Application Data
(63) Continuation of application No. PCT/EP2023/083068, filed on Nov. 24, 2023.

(30) Foreign Application Priority Data
Nov. 25, 2022 (GB) 2217719.0

(51) Int. Cl. B66F 9/06; B66F 9/065; B66F 9/075

(52) U.S. Cl. CPC B66F 9/063; B66F 9/065; B66F 9/0755; B66F 9/07586

(57) ABSTRACT

A pallet mover for moving a pallet, the pallet comprising: a top deck and a lower deck formed from one or more planks, the lower deck being spaced apart from the top deck, and the pallet mover comprising: a main body comprising a lifting mechanism and a drive assembly for moving the pallet mover; a plurality of forks for lifting and handling pallets, the plurality of forks outwardly extending from the main body and configured to be lifted by the lifting mechanism; and an independently movable first set of wheels and an independently movable second set of wheels, the first set of wheels configured to move vertically to disengage and engage with the floor, such that the first set of wheels are configured to step over the one or more planks of the pallet when the plurality of forks are inserted into the pallet.

### CROSS-REFERENCE TO RELATED APPLICATIONS

This application is a continuation of PCT International Patent Application No. PCT/EP2023/083068, filed on Nov. 24, 2023, which claims priority to UK Patent Application No. GB2217719.0, filed on Nov. 25, 2022, the entire contents of which are hereby incorporated by reference.

### TECHNICAL FIELD

The disclosure relates to a vehicle, and in particular to a pallet mover which can be operated in a storage facility, such as a warehouse or fulfilment center, for example.

### BACKGROUND

Many goods are transported and/or stored on pallets. Pallets come in various types and generally comprise a top deck usually formed from a series of planks, otherwise known in the art as runners and a lower deck spaced from the top deck by blocks of wood. As with the top or upper deck, the lower deck is usually formed from a series of planks nailed to the blocks of wood to improve the rigidity of the pallet. Such pallets are generally called block or deck board pallets. Instead of the use of blocks to space the top and lower decks, planks disposed at right angles to the planks at the top deck can be used to space the top deck from the lower deck. The spacing between the top and lower decks can be arranged so as to allow the forks of a fork lift truck or pallet truck to enter the pallet two ways or four ways, whereby four way pallets allow the forks of the pallet truck to enter the pallet through four sides of the pallet and two way pallets only allow the forks of the of the pallet truck to enter the pallet through two sides of the pallet. For obvious reasons, the four-way pallet is the most common type of pallet. There are two main styles of pallets that allow entry of the forks in four ways. These are commonly known as open pallets and full perimeter pallets. Open pallets usually have three planks or runners running longitudinally in the lower deck of the pallet and in the full perimeter pallets the runners or planks in the lower deck are connected to the spacers at their respective ends.

There are various types of pallet trucks known in the art to move the pallets and these are generally categorized as either manual or powered pallets trucks. Manual pallet trucks typically have a frame or main body with forks extending therefrom, a truck supported on a pair of rear wheels and a hydraulic jack connected to the truck and the frame or main body. The jack, which is typically a hydraulic bottle jack, is operated by pivotally pumping a steering handle of the pallet truck up and down which causes the hydraulic bottle jack to raise the frame and thus, the forks off the ground. Once the pallet has been raised by pumping the handle, an operator may steer the pallet truck by turning the handle relative to the truck. To maneuver the pallet truck on the ground, the hydraulic jack typically has one or more steering wheels and each fork usually has either a single wheel or two wheels at the front of the pallet truck. The front wheels are usually on the inside of the forks and are mounted on levers attached to linkages that go to the levers attached to the hydraulic jack. When the hydraulic jack is raised (as a result of the pumping the handle) the linkages force the front wheels down which in turn forces the forks to raise vertically above the wheels, raising the load in the fork upwards until it is not in contact with the floor anymore. Mounting the front wheels on levers prevents the pallet truck from toppling when the frame of the pallet truck connected to the fork is lifted by the hydraulic jack. In comparison to the manual pallet truck, the hydraulic jack and/or the steering wheels are motorized in a powered pallet truck to allow lifting and moving of heavier stacked pallets. The powered pallet jack is generally moved by a throttle on the handle to move forwards or in reverse and steered by swinging the handle in the intended direction. Like the manual pallet truck, wheels are mounted at the front of the forks to prevent the powered pallet truck from tipping, particularly when pallets carry a heavy load.

Instead of mounting wheels at the front of the forks, to prevent tipping of the power pallet truck, the weight of the main body of the power pallet trucks can be made sufficiently large to counterweight any loads lifted by the forks. Such power pallet trucks comprise J-forks that are configured to enter into the spacing between the upper and lower deck of the pallet. Without the additional weight to the main body of the power pallet truck, there is the risk that the powered pallet truck may topple when lifting heavy loads. In some cases, the main body of the power pallet truck is made intentionally heavy, e.g. using cast iron weights, to counterbalance any weight lifted by the forks. Alternatively, a similar arrangement to the manual pallet truck can be adopted where each of the wheels are mounted to the front of the fork via levers that extend the wheels vertically when the forks are lifted so as to prevent the pallet truck from toppling.

However, mounting the wheels on the inside of the forks via levers connected to the hydraulic jack has drawbacks when trying to insert the forks into the pallet. This is because the wheels have to ride over the planks in the lower deck of the pallet in order for the forks to be inserted into the space between the top and lower deck of the pallet. In some cases, an operator of the pallet truck has to forcefully push the pallet fork with sufficient force to cause the front wheels to ride over one or more planks in the lower deck of the pallet. Once the forks are inserted into the spacing of the pallet, the operator can then lift the pallet clear off the ground by pumping the hydraulic jack as discussed above. Depending on the thickness of the planks in the lower deck of the pallet, this force can be great to the extent that an operator has to take a run up in order to ride over the planks in the lower deck of the pallet. The movement of the forks during insertion of the forks into the pallet may also cause damage to the pallet and the extent of the damage is dependent on the speed of the forks when inserted into the pallet.

A well-run warehouse is well-organized and maintains an accurate inventory of goods. Goods can come and go frequently, throughout the day, in a warehouse. Some large and very busy warehouses work three shifts, continually moving goods throughout the warehouses as they are received or needed to fulfil orders. With the trend toward automated and unmanned production systems in the transportation industry, there is an increasing use of Automated Guided Vehicles (AGV) responsible for transporting products within warehouses. An AGV is a mobile robot that follows markers or wires in the floor, or uses vision or lasers to make its way without direct or remote control by an operator. The main body of an autonomous fork lift truck comprises a driving mechanism and lifting mechanism for autonomously lifting the pallet and any items supported thereon and moving the fork lift truck around the warehouse. Like the manual and power pallet truck, an autonomous forklift truck comprises forks comprising wheels in the inside of the forks that are configured to be inserted into the pallet.

The force required for the wheels on the inside of the forks can be variable and largely depends on the thickness of the planks in the lower deck of the pallet. To provide sufficient force for the wheels on the inside of the forks ride over one or more plank in the lower deck of the pallet, not only requires a drive mechanism that provides sufficient torque for the wheels to ride over the one or more planks but introduces more complexity in the drive mechanism of the autonomous pallet truck. To overcome the need of the wheels on the inside of the forks to ride over one or more planks in the lower deck of the pallet, the forks of the autonomous fork lift truck are counterbalanced by the weight of the frame or main supporting the forks. As a result, the maximum weight of any loads lifted by the autonomous pallet truck is very much limited to the weight of the main body of the autonomous pallet truck. As a result, the main body of the autonomous pallet truck is made intentionally heavy to counterbalance any loads lifted by the forks. The increased weight of the main body of the autonomous pallet truck introduces other issues including the need to provide enough power to drive the autonomous pallet truck on the floor which in turn may require larger motors to provide enough power to the motors driving the autonomous pallet truck.

A pallet mover is required that does not suffer from the problems discussed above.

### SUMMARY

The present invention has mitigated the above problem by providing a pallet mover, wherein wheels mounted to the plurality of forks are configured to step over one or more planks or runners in the lower deck of the pallet. This allows the plurality of forks to be inserted into the pallet without the need to physically ride or bump over the one or more planks. In order for the plurality of forks of the pallet mover to be inserted into the pallet, more specifically between the spacing between the upper and lower decks of the pallet, the plurality of forks comprises a first set of wheels and a second set of wheels, the first set of wheels being spaced apart from the second set of wheels such that the first set of wheels can be configured to step over one or more planks in the lower deck of the pallet.

More specifically, the present disclosure provides a pallet mover for moving a pallet, said pallet comprising a top deck formed from one or more planks; and a lower deck formed from one or more planks, the lower deck being spaced apart from the top deck, the pallet mover comprising: a main body comprising a lifting mechanism and a drive assembly for moving the pallet mover; a plurality of forks for lifting and handling pallets, the plurality of forks outwardly extending from the main body and configured to be lifted by the lifting mechanism; and a first set of wheels and a second set of wheels, each of the first and second sets of wheels being independently moveable relative to the plurality of forks, the first set of wheels being configured to be moveable in a vertical direction between a retracted position to disengage from the floor and an deployed position to engage with the floor such that, in use, the first set of wheels steps over the one or more planks in the lower deck of the pallet when the plurality of forks are inserted into the pallet.

Another way of claiming the present disclosure is to provide a pallet mover, said pallet comprising a top deck formed from one or more planks and a lower deck formed from one or more planks, the lower deck being spaced apart from the top deck, the pallet mover comprising: a main body comprising a lifting mechanism and a drive assembly for moving the pallet mover; a plurality of forks for lifting and handling pallets, the plurality of forks outwardly extending from the main body and configured to be lifted by the lifting mechanism; a first set of wheels and a second set of wheels, each set of the first and second sets of wheels being configured to be independently moveable relative to the plurality of forks; and a control system operable to independently move the first set of wheels between a deployed position to engage with the floor and a retracted position to disengage from the floor such that, in use, the first set of wheels steps over the one or more planks of the pallet when the plurality of forks are inserted into the pallet.

In a first aspect of the present disclosure, the plurality of forks comprises a first and second set of wheels that are configured to step over one or more planks in the lower deck of the pallet. For the first and second sets of wheels to step over the one or more planks in the lower deck of the pallet, each of the first and second set of wheels are configured to be independently moveable in a vertical direction between a deployed position to engage with the floor and a retracted position to disengage from the floor such that, in use, the first or the second set of wheels are in contact with the floor at any one time. The first set of wheels being spaced apart from the second set of wheels such that the first set of wheels is proximal to the distal ends of the plurality of forks and the second set of wheels is proximal to the main body of the pallet mover. The second set of wheels function as balancing wheels in order for the first set of wheels to be retracted. Optionally, the first and second sets of wheels are configured not to contact the one or more planks of the pallet when stepping over the one or more planks of the pallet. To enable each set of the first and second sets of wheels to independently move in a vertical direction, optionally, each wheel of the first and/or second sets of wheels is pivotally mounted to the plurality of forks.

The first set of wheels proximal the distal end of the plurality of forks function as load bearing wheels as they can be configured to bear the weight of the pallet and any loads carried by the pallet when raising the plurality of forks. The second set of wheels spaced further away from the distal end of the plurality of forks can be configured to function as balancing wheels to stabilize the pallet mover and prevent the pallet mover from tipping when the first set of wheels retract. To raise or lower the plurality of forks, optionally, the first or second sets of wheels cooperates with the lifting mechanism such that movement of the first or second sets of wheels in a vertical direction raises or lowers the plurality of forks. Optionally, the lifting mechanism is configured to lift the plurality of forks by extending the first set of wheels when in the deployed position in the vertical direction relative to the plurality of forks. For example, the lifting mechanism can comprise a hydraulic pump and/or electric motor which is coupled to the first and/or second sets of wheels by one or more levers to raise or lower the plurality of forks.

It is not necessary that each of the first and the second sets of wheels is independently moveable in the vertical direction for the plurality of forks to be inserted into the pallet. In a second aspect of the present disclosure, the second set of wheels engages with the floor and is configured to be retractable in a longitudinal direction along the plurality of forks between a forward position and a retracted or rearward position, the forward position being closer to the first set of wheels than in the retracted position. Like the first aspect of the present disclosure, the second set of wheels is configured as balancing wheels to stabilize the pallet mover so as to prevent the pallet mover from tipping when the first set of wheels is in the retracted configuration. To enable the plurality of forks to be inserted fully into the pallet when the first set of wheels is in the retracted position, the second set of wheels is configured to be retractable in a longitudinal direction (substantially horizontal direction) along the plurality of forks between a forward position and a retracted position, the forward position being closer to the first set of wheels than the retracted position. For this purpose the retracted position can be termed “rearward” position. The second set of wheels retract in a substantially horizontal direction relative to the plurality of forks as the plurality of forks are inserted into the pallet. The second set of wheels maintain the stability of the pallet mover as the plurality of forks are inserted into the pallet. Once fully inserted into the pallet, the first set of wheels can be deployed to the extended position to raise the plurality of forks. Optionally, the second set of wheels is biased in the forward position such that when the plurality of forks are inserted into the pallet, the second set of wheels retract by butting up against the lower deck of the pallet.

To configure the first and second sets of wheels to be independently moveable relative to the plurality of forks, optionally, the pallet mover further comprises an actuation mechanism operable to independently move the first set of wheels and/or the second set of wheels relative to the plurality of forks. To actuate the actuation mechanism, the pallet mover further comprises a control system configured to actuate the actuation mechanism to independently move the first set of wheels and/or the second set of wheels relative to the plurality of forks. Preferably, the actuating mechanism is configured to actuate the lifting mechanism to independently move the first and/or second sets of wheels in the vertical direction. Preferably, the pallet mover is an AGV. Preferably, the pallet mover is an autonomous pallet mover comprising a location recognition sensor for detecting a location of the pallet mover in a travelling direction, said control system being configured to move the pallet mover in response to one or more signals from the location recognition sensor (herein defined as a pallet mover). Optionally, the location recognition sensor comprises a LiDAR sensor comprising a laser beam source; an optical receiver and a scanning system for deflecting a laser beam generated by the laser beam source in at least two scanning directions.

To insert the plurality of forks of the pallet mover in the first aspect of the present disclosure into the pallet, the control system is configured to retract the first or the second set of wheels when the second or first set of wheels is in the deployed position. Thus, when the first set of wheels retract, the second set of wheels remain in the deployed position to balance the plurality of forks and vice versa. This enables the first and/or second sets of wheels to step over one or more planks in the lower deck of a pallet. Similarly, to insert the plurality of forks of the pallet mover according to the second aspect of the present disclosure into the pallet, the control system is configured to extend the first set of wheels in the vertical direction when the first set of wheels is in the deployed position to raise the plurality of forks. Optionally, the control system is configured to retract the second set of wheels in a longitudinal direction along the plurality of forks to enable the plurality of forks to be inserted into the pallet. Preferably, the first set of wheels is proximal to the distal end of the plurality of forks and the second set of wheels is proximal to the main body of the pallet mover. For example, in the first aspect of the present disclosure, where the second set of wheels is proximal to the main body of the pallet mover and the first set of wheels is proximal to the distal end of the plurality of forks, retracting the first set of wheels whilst the second set of wheels remain in the deployed position allows the first set of wheels to step over one or more planks in the lower deck of the pallet. The process is followed by deploying the first set of wheels to balance the plurality of forks when the second set of wheels are retracted so as to allow the second set of wheels to step over the one or more planks in the lower deck of the pallet. This enables both first and second sets of wheels to step over the one or more planks in the lower deck of the pallet when the plurality of forks are inserted into the pallet.

In the second aspect of the present disclosure, the second set of wheels remain engaged with the floor to balance or stabilize the pallet mover and the first set of wheels remain in the retracted position when the plurality of forks are inserted into the pallet. The first set of wheels is subsequently deployed when the plurality of forks are fully inserted into the pallet. In both cases, the first set of wheels bears the load of the pallet and any items mounted on the pallet when the pallet is lifted and the second set of wheels maintains the balance of the plurality of forks in a substantially horizontal orientation when the first set of wheels are retracted when stepping over one or more planks in the lower deck of the pallet. The second set of wheels can function as balancing wheels when the first set of wheels retract.

Thus, to insert the plurality of forks into the pallet according to the first aspect of the present disclosure, optionally, the control system in cooperation with the drive assembly is configured to move the pallet mover in a predetermined sequence of: moving the pallet mover a first distance when the first set of wheels is retracted and the second set of wheels is deployed; and moving the pallet mover a second distance when the second set of wheels is retracted and the first set of wheels is deployed.

The control system is configured to move the pallet mover a first distance when the first set of wheels have been retracted and the second set of wheels is deployed in order to insert at least a portion of the plurality of forks into the pallet. Subsequently, the first set of wheels is deployed to engage with the floor and the second set of wheels can be retracted to allow the plurality of forks to be inserted a second distance into the pallet. The first distance and/or second distance can correspond to the width of one or more planks in the lower deck of a pallet. The first and/or second distance can be predetermined in a storage device and the control system can be configured to execute instructions stored in the storage device to independently move the first and second sets of wheels depending on the separation between the first and second sets of wheels. The greater the spacing between the first and second sets of wheels, the reduced number of operations to independently retract and deploy the first and second sets of wheels when stepping over one or more planks in the lower deck of the pallet than for a smaller spacing. To step over one or more planks in the lower deck of the pallet, optionally, the first distance can be substantially equal to or different to the second distance.

To deploy and retract the first and second sets of wheels, optionally, the actuation mechanism comprises at least one linear actuator. The first and second sets of wheels are independently moveable in their respective vertical direction by at least one linear actuator.

To sense the presence of one or more planks in the lower deck of the pallet so as to engage the actuation mechanism to independently move the first and second sets of wheels in the vertical direction, the pallet mover further comprises a proximity sensor for detecting the presence of an obstacle, said proximity sensor being in cooperation with the actuation mechanism such that, in use, the actuation mechanism is configured to actuate movement of the first or second set of wheels in the vertical direction in response to a signal from the proximity sensor. Examples of proximity sensors include but is not limited to LiDAR or even a vision system comprising one or more cameras for visualizing the presence of an obstacle. Optionally, the proximity sensor is disposed at the distal end of at least one of the plurality of forks relative to the main body.

To move the pallet mover, preferably, the drive assembly comprises a drive wheel rotatable about a drive axis and a drive mechanism for driving the drive wheel about the drive axis. To maneuver the pallet mover within a warehouse, preferably, the pallet mover further comprises a steering mechanism for changing direction of the pallet mover. Optionally, the steering mechanism is coupled to the drive wheel and being configured for rotating the drive wheel about a steering axis that is substantially perpendicular to the drive axis of the drive wheel.

Whilst the maneuverability of the pallet mover can be autonomously controlled, there are occasions where the movement of the pallet mover would need to be manually driven by an operator. Examples where the autonomous control of the pallet mover would need to be manually overridden include but are not limited to the pallet mover trying to negotiate a tight corner or obstacle, trying to free up the pallet mover, or simply manually taking control of the maneuverability of the pallet mover. To manually override the movement of the pallet mover when in an autonomous mode, the pallet mover further comprises a user manual interface that is configured to manually override the autonomous control of the pallet mover to move the pallet mover, the user manual interface has an interface portion that is configured to couple with the steering mechanism and the drive assembly such that the user manual interface controls the direction and movement of the pallet mover. Optionally, the interface portion electrically couples with the steering mechanism and the drive assembly. For example, once the control system detects that the user manual interface is coupled to the main body of the pallet mover, the control system can switch the pallet mover from an autonomous mode to a manual mode. Once in the manual mode of operation, the user manual interface can be operated manually to control the steering mechanism and the drive assembly of the pallet mover.

To remove the burden of carrying the extra weight of the user manual interface when in the autonomous mode and/or to switch to another pallet mover, optionally, the user manual interface is detachable from the main body of the pallet mover. For example, the user manual interface can be de-coupled from the main body of the pallet mover when in the autonomous mode. To enable the user manual interface to detach from the main body of the pallet mover, optionally, the user manual interface comprises a body and a wheel assembly for moving the body. Optionally, the user manual device comprise a manual steering mechanism coupled to the wheel assembly for steering the body of the user manual device. To allow the user manual interface to be driven independently of the pallet mover, optionally, the user manual device comprises an independent drive mechanism coupled to the wheel assembly. This allows the user manual device to be detached from the pallet mover and coupled onto another pallet mover to control its movement.

Optionally, the pallet mover further comprises a coupling sensor for switching the pallet mover between an autonomous mode and a manual mode of operation in response to one or more signals from the coupling sensor. For example, the user manual interface and/or the main body of the pallet mover comprises the coupling sensor that is configured to switch operation of the pallet mover between the autonomous mode and the manual mode via the control system in response to one or more signals from the coupling sensor.

Optionally, the manual steering mechanism comprises a tiller arm or a steering wheel. Optionally, the tiller arm is moveable along an arc between a substantially horizontal position and a substantially vertical position. For example, the tiller is rotatable right and left to steer the pallet mover. The present disclosure further provides a method of moving/handling a pallet by a pallet mover according to the first aspect of the present disclosure, comprising the steps of independently moving the first and second sets of wheels in a vertical direction so as to step over one or more planks in the lower deck of the pallet when the plurality of forks are inserted into the pallet.

Preferably, the first and second sets of wheels steps over the one or more planks in the lower deck of the pallet by the steps of: retracting the first set of wheels so as to disengage the first set of wheels from the floor; moving the pallet mover towards the pallet so that at least a portion of the plurality of the forks enters the pallet; deploying the first set of wheels so as to engage the first set of wheels with the floor; retracting the second set of wheels so as to disengage the second set of wheels from the floor; and moving the pallet mover towards the pallet so that an increased portion of the plurality of the forks enters the pallet compared to that in the second step.

The present disclosure further provides a method of moving/handling a pallet by a pallet mover according to the second aspect of the present disclosure by the steps of: moving the pallet mover a first distance towards the pallet so that a first portion of the plurality of the forks enters the pallet; retracting the second set of wheels in a longitudinal direction along the plurality of forks relative to the plurality of forks; and moving the pallet mover a second distance towards the pallet so that a second portion of the plurality of the forks enters the pallet.

Once inserted into the pallet, the method further comprising the step of raising the plurality of forks by extending the first set of wheels in a substantially vertical direction.

Thus, instead of moving the first and second set of wheels of the pallet mover in a substantially vertical direction to step over one or more planks in the lower deck of the pallet, the first set of wheels proximal to the distal end or free end of the plurality of forks remain in the retracted position to enable the plurality of forks to be inserted a first distance into the pallet (i.e. between the upper and lower decks of the pallet). The second set of wheels remain engaged with the floor to stabilize the pallet mover as the plurality of forks are inserted into the pallet. The second set of wheels retract in a longitudinal direction along the plurality of forks as the plurality of forks are inserted a further, second distance into the pallet. The second distance enable the plurality of forks to be inserted fully into the pallet. Preferably, the method further comprises the step of raising the plurality of forks by extending the first set of wheels in a substantially vertical direction.

### DESCRIPTION OF THE DRAWINGS

Further features and aspects of the present disclosure will be apparent from the following detailed description of an illustrative example made with reference to the drawings, in which:

FIG. 1 is a schematic drawing of a pallet mover according to a first example of the present disclosure approaching a pallet.

FIG. 2A-2G are schematic drawings of the pallet mover shown in FIG. 1 engaging with a pallet; where FIG. 2A shows the first set of wheels retracted and the second set of wheels are deployed; FIG. 2B shows at least a portion of the plurality of forks are inserted into the opening of the pallet to step over a first plank in the lower deck of the pallet; FIG. 2C shows the first set of wheels deployed and the second set of wheel retracted so as to allow the plurality of forks to be inserted further into the pallet; FIG. 2D shows the plurality of forks inserted further into the pallet to step over a first plank in the lower deck of the pallet; FIG. 2E shows the first set of wheels retracted so as to allow the plurality of forks to step over the second plank in the lower deck of the pallet; FIG. 2F shows the first set of wheel deployed and the second set of wheels retracted to complete the operation of the pallet mover engaging with the pallet; and FIG. 2G shows the plurality of forks raised to lift the pallet.

FIG. 3 is a schematic drawing of a pallet mover according to a second example of the present disclosure approaching a pallet.

FIG. 4A-4C are schematic drawings of the pallet mover shown in FIG. 3 engaging with a pallet; where FIG. 4A shows the first set of wheels retracted and the second set of wheels deployed; FIG. 4B shows the first set of wheels deployed and the second set of wheels retracted so as to allow the plurality of forks to be inserted further into the pallet; FIG. 4C shows the first set of wheels deployed and the second set of wheels retracted to complete the operation of the pallet mover engaging with the pallet

FIG. 5 is a block diagram showing the main components of the pallet mover for engagement with a pallet.

FIG. 6 is a flow diagram showing an example of the steps the pallet mover undertakes when engaging with the pallet.

FIG. 7A-7E are schematic drawings showing the steps undertaken by a pallet mover according to a second example of the present disclosure when engaging with the pallet; where FIG. 7A shows the first set of wheels in a retracted position and the second set of wheels in a forward position relative to the plurality of forks to maintain the stability of the pallet mover as the pallet mover moves on the floor; FIG. 7B shows that the second set of wheels approaching the lower deck of the pallet as the plurality of forks enters the pallet; FIG. 7C shows further movement of the pallet mover toward the pallet, thereby increasing the proportion of the plurality of forks entering the pallet and also causing the second set of wheels to butt up against the lower deck of the pallet, and, more specifically, a plank in the lower deck of the pallet; FIG. 7D shows that the action of FIG. 7C causes the second set of wheels to retract in a rearward direction away from the first set of wheels as the plurality of forks are driven into the pallet; FIG. 7E shows that once the plurality of forks have fully engaged with the pallet, the lifting mechanism is actuated to extend the first set of wheels in a vertical direction to engage with the floor to stabilize the pallet mover on the floor as the plurality of forks are raised.

FIG. 8 is a perspective view of a pallet mover incorporating a user manual interface according to a third example of the present disclosure.

FIG. 9 is a perspective view of the pallet mover comprising a detachable user manual interface according to the third example of the present disclosure.

FIG. 10 is a perspective view of an inbound area of a warehouse showing the unloading of the pallets from the trailers using the pallet mover according to the third example of the present disclosure.

FIG. 11 is a perspective view of a pallet mover with an integrated user manual interface showing the pallet mover in the manual mode of operation according to the third example of the present disclosure.

FIG. 12 is a perspective view of the pallet mover shown in FIG. 11 showing the pallet mover in an autonomous mode of operation.

FIG. 13 is a perspective view another example of the pallet mover comprising a detachable user manual interface according to the third example of the present disclosure.

FIG. 14 is a perspective view of an inbound area of a warehouse showing the unloading of the pallets from the trailers using the pallet mover shown in FIG. 13.

### DETAILED DESCRIPTION

With the trend towards automated and unmanned production systems in a warehouse or logistics center, the present disclosure provides a pallet mover that improves the flexibility by which the forks of the pallet mover can engage with a pallet. With the move towards the use of autonomous guided vehicles (AGV) for transporting items within a warehouse, there is an increasing need for the AGV to have the ability to autonomously make accurate and safe work capability in any work environment. In various forms of the example of the present disclosure, the pallet mover can be or take the form of an automated guided vehicle (AGV) such as a vision guided vehicle as an example. In some examples of the present disclosure, the pallet mover can be an AGV/VGV pallet mover configured with object sensing technology known in the art.

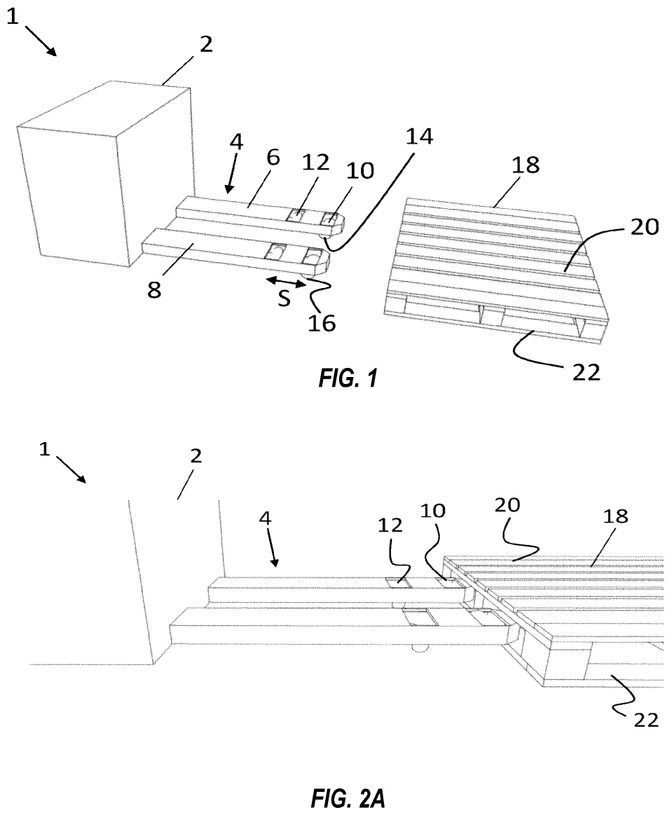

One of the complications of making the pallet mover autonomous (herein referred to as “an autonomous pallet mover or robotic pallet mover”) is the ability of the forks of the pallet mover to be inserted into the space between the upper and lower decks of the pallet in order to engage with the pallet. Traditionally, for a manual pallet mover, to engage with a pallet, the forks would need to be forcibly pushed into the space between the upper and lower decks of the pallet so that the wheels that stabilizes the pallet mover can enter into the space. In the case of open or full perimeter type pallets where the entrance into the pallet can be two or four ways, the lower deck of the pallet comprises at least there planks or runners (see FIG. 1) to improve the rigidity of the pallet. To engage with the pallet, the wheels proximal the distal end of the forks has to physically ride or bump over one or more of the planks in the lower deck of the pallet. Complications arises when making the pallet mover autonomous as the pallet mover would need to gauge the number and/or the thickness of each of the planks in the lower deck of the pallet so as to determine the force necessary to allow the stabilizing wheels proximal the distal end of the forks to physically ride over the planks in the lower deck of the pallet.

In accordance of the present disclosure, the plurality of forks of the pallet mover comprises a first and second sets of wheels, each set of the first and second sets of wheels is configured to move independently in a vertical direction relative to the plurality of forks between a deployed position to engage with the floor and a retracted position to disengage from the floor. The first and second sets of wheels are spaced apart so as to enable the first and second sets of wheels to step over one or more of the planks in the lower deck of the pallet. To step over one or more planks in the lower deck of the pallet, the spacing between the first and second sets of wheels correspond to or greater than the width of the one or more planks in the lower deck of the pallet so as to enable the first and second sets of wheels to clear the one or more plank when engaging with the pallet. The spacing between the first and second sets of wheels can be defined as the spacing S between the centers of a wheel of the first and second sets of wheels (see FIG. 1)

The first set of wheels proximal the distal end of the plurality of forks function as load bearing wheels as they bear the weight of the pallet and any loads carried by the pallet when raising the plurality of forks. The second set of wheels spaced further away from the distal end of the plurality of forks function as balancing wheels to stabilize the pallet mover from tipping when the first set of wheels retract. Equally, the first set of wheels stabilizes the pallet mover from tipping when the second set of wheels retract. Thus, each of the first and second sets of wheels independently deploy and retract when stepping over one or more planks in the lower deck of the pallet. The first and second sets of wheels can respectively be defined as front and rear set of wheels.

An example of a pallet mover 1 according to the present disclosure is shown in FIG. 1 and comprises a main body 2 comprising a drive assembly (not shown) for moving the pallet mover on the floor, a steering mechanism (not shown) for maneuvering the pallet mover 1 and a lifting mechanism (not shown) for raising and lower the plurality of forks 4 extending from the main body 2. In the particular example of the present disclosure shown in FIG. 1, the pallet mover 1 comprises two forks defining a left fork 6 and a right fork 8. The first 10 and second 12 sets of wheels are mounted to the left 6 and right 8 forks in the sense that half of the wheels of the first 10 and second 12 sets of wheels are mounted to the left forks 6 and the other half of the wheels of the first 10 and second 12 sets of wheels are mounted to the right fork 8. For ease of explanation of the present disclosure, each set of the first and second sets of wheels 10, 12 comprise a first wheel 14 and a second wheel 16. The first wheel 14 and second wheel 16 of each of the first and second sets of wheels 10, 12 are shown mounted to respective left and right forks 6, 8 of the pallet mover 1.

The first and second sets of wheels 10, 12 are shown rotatably mounted on the inside of the forks 4 but other means to rotatably mount the first and second sets of wheels 10, 12 to the plurality of forks 4 in order for the plurality of forks 4 to move on the floor are permissible in the present disclosure. The number of forks is not limited to two forks and can include any number of forks, e.g. a pallet mover with triple forks. To be able to move in a vertical direction, each wheel of the first and second sets of wheels 10, 12 can be pivotably mounted to the plurality of forks 4. For example, each wheel of the first and second sets of wheels 10, 12 can be mounted to levers (not shown) pivotally mounted to the plurality of forks 4 that retract in a vertical direction to retract each wheel towards the inside of their respective fork and thereby, disengage from the floor and extend outwardly of their respective fork in the deployed position to engage with the floor. However, other means to mount each set of the first and second sets of wheels 10, 12 to enable vertical movement relative to the plurality of forks 4 is permissible in the present disclosure. An actuation mechanism (not shown) coupled to the first and second sets of wheels 10, 12 is configured to independently move each set of the first and second sets of wheels in the vertical direction. Further detail of the actuation mechanism is discussed below.

Connected to the plurality of forks is the lifting mechanism (not shown) for raising and lowering the plurality of forks. Various lifting mechanisms commonly known in the art can be used to raise and lower the plurality of the forks. These include but is not limited to a hydraulic pump, electric motor etc. Typically, the plurality of forks are connected to a frame forming the main body of the pallet mover and the lifting mechanism is connected to the plurality of forks and the frame such that the lifting mechanism is configured to raise and lower the frame and the plurality of forks. The lifting mechanism can cooperate with the first or the second set of wheels to raise or lower the plurality of forks. For example the plurality of forks can be raised by lowering the first or second sets of wheels. The first set of wheels can be mounted on levers attached to linkages that go to levers attached to the hydraulic pump in the main body of the pallet mover that lowers the first or second set of wheels so as to raise the plurality of forks. As the first set of wheels may be primarily the load bearing wheels, the first set of wheels can be lowered to raise the plurality of forks. The lower the first set of wheels relative to the plurality of forks, the higher the plurality of forks is raised. Alternatively, the lifting mechanism for raising the plurality of forks can be separate to the first and second sets of wheels. However, the first or second set of wheels lowers as the plurality of forks are lifted. A locking mechanism locks the first or second set of wheels in the lowered positioned when the plurality of forks is in the raised position so as to raise a pallet engaged with the plurality of forks off the ground.

A drive assembly (not shown) comprising one or more drive wheels propels the pallet truck on the floor. For a powered pallet mover, the drive assembly comprises a drive mechanism, e.g. drive motor, for driving rotation of one or more drive wheels about a drive axis. The drive assembly is located at the rear of the pallet mover within the main body. The drive wheel for propelling the pallet mover on the floor can be connected to a steering mechanism (not shown) for maneuvering the pallet mover on the floor. The steering mechanism can be configured to rotate the one or more of the drives wheels about a steering axis that is substantially perpendicular to their drive axis to change direction of the pallet mover on the floor. Various steering mechanisms known in the art can be used to change direction of the pallet mover. These include but is not limited to a steering driving unit coupled to the one or more drive wheels that is configured to rotate one or more of the drive wheels about the steering axis. For example, the main body of the pallet mover may include swivel casters located at four corners of the main body of the pallet mover. The drive wheel and steering wheels respectively propels and changes direction of the main body of the pallet mover. The steering mechanism can be separate to the drive assembly in the sense that a separate steering wheel can be used to change direction of the pallet mover independent to propelling the pallet mover by the drive assembly.

For an AGV (automated guided vehicle), the pallet mover may include a guidance system (not shown) coupled to the drive assembly and steering mechanism to control the movement of the pallet mover on the shop floor. The guidance system may include but is not limited to wire guidance, laser guidance, magnetic tape guidance, odometry guidance, inertial guidance or optional guidance. For example, laser guidance systems use special markers that the AGV pallet mover senses and uses to control its travel. The guidance system is controlled by a control system comprising a controller, e.g. processor and a memory storage device for storing instructions executed by the controller for controlling the operation of the pallet mover. The control system can be a central controller remote from the AGV and communicates with the AGV by wireless means or alternatively, the control system can be internal of the AGV which receives instructions stored in the memory storage device. The memory storage device can be any storage device commonly known in the art and include but is not limited to a RAM, computer-readable medium, magnetic storage medium, optical storage medium or other electronic storage medium which can be used to store data and accessed by the controller. Controlling the operation of the pallet mover include but is not limited to controlling the drive assembly and the steering mechanism in response to signals from the guidance system to control the travel of the pallet mover; controlling the vertical movement of the first and second sets of wheels mounted to the plurality of forks to engage with a pallet and controlling the lifting mechanism to raise and lower a pallet. The pallet mover may further comprise a battery (or some other power source) to power the different components discussed above. The pallet mover may comprise an interface such that a battery may be re-charged or the battery may be hot-swapped to enable continued of the pallet mover. The pallet mover further comprises a wireless interface to allow it to receive data from the central controller and to send data back to the central controller, for example status message, data logs, etc.

Whilst known systems can be used in the present disclosure to control the movement of the pallet mover, the present disclosure is more focused on the engagement of the plurality of forks 4 with a pallet 18. To engage the plurality of forks 4 with the pallet 18, the control system in cooperation with the actuation mechanism and drive mechanism is configured to move the pallet mover so as to fully engage with the pallet. The term “fully” engage the plurality of forks with the pallet is used to describe the condition where the plurality of forks are inserted within the pallet so that it can be lifted off the floor. The actuation mechanism can comprise a linear actuator to move each of the first and second sets of wheels in a vertical direction via one or more linkages. The control system can be configured to actuate the actuation mechanism to independently move the first and the second set of wheels in the vertical direction. For example, the actuation mechanism can comprise a first linear actuator for raising and lowering the first set of wheels and a second linear actuator for raising and lowering the second set of wheels. To independently move the first set of wheels and the second set of wheels in the vertical direction, the control system can be configured to independently actuate the first linear actuator to deploy or retract the first set of wheels and the second linear actuator to deploy or retract the second set of wheels. Alternatively, or in combination with the linear actuator, the actuation mechanism can comprise a cam mechanism comprising one or more cams and a cam follower moveable along the one or more cams to move the cam follower from a raised position to retract the first and/or second sets of wheels and a lowered position to deploy the first and/or second sets of wheels.

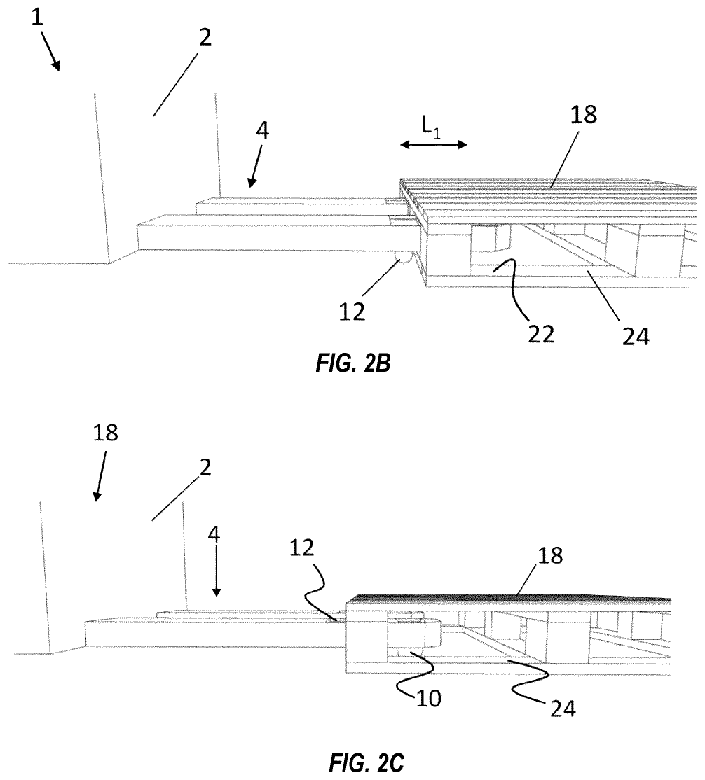

FIG. 2A-2G are schematic drawings showing the stages the plurality of the forks 4 engaging with the pallet 18. The engagement operation involves independently retracting and deploying the first and second set of wheels 10, 12 in a predetermined sequence in conjunction with driving the pallet mover 1 towards the pallet 18. The operation begins with retracting the first set of wheels 10 proximal the distal end of the plurality of forks 4 (i.e. front set of wheels) so as to allow the front portion of the plurality of forks 4 to be inserted into the opening provided by the space between the upper 20 and lower 22 decks of the pallet 18. In FIG. 2B, the pallet mover 1 moves a first distance L₁ towards the pallet 18 so that the front portion of the plurality of forks 4 clears a plank or runner 24 in the lower deck 22 of the pallet 18. The first distance is dependent on the spacing between the first and second sets of wheels 10, 12. In the particular example of the present disclosure, the first distance is sufficient to step over a single plank 24 in the lower deck 22 of the pallet 18 without the second set of wheels 12 proximal to the main body 2 of the pallet mover 1 physically riding or bumping over the single plank as shown in FIG. 2B. The first distance L₁ can be a predetermined distance applicable to a type of pallet stored in the memory storage device and can be dependent on the width of one or more planks 24 in the lower deck 22 of the pallet 18. Once the pallet mover 1 has moved the first distance L₁ towards the pallet 18 so that the front portion of the plurality of forks 4 enters the pallet 18, the engagement operation proceeds with the deploying the first set of wheels 10 into engagement with the floor followed by retracting the second set of wheels 12 as shown in FIG. 2C. Deploying the first set of wheels 10 prior to retracting the second set of wheels 12 maintains the stability of the pallet mover 1 and prevent it from tipping when the second set of wheels 12 are retracted. This enables the pallet mover 1 to move a second distance L₂ towards the pallet 18 to cause the plurality of forks 4 to be inserted further into the pallet 18 as shown in FIG. 2D. Like the first distance, the second distance can be a predetermined distance applicable to a type of pallet that is stored in the memory storage device. The predetermined sequence of operations of: retracting the first set of wheels, moving the pallet mover a first distance towards the pallet; deploying the first set of wheels and retracting the second set of wheels; and moving the pallet mover a second distance towards the pallet; repeating when stepping over a second plank in the lower deck of the pallet as shown in FIG. 2E and FIG. 2f. As there are typically three planks or runners 24 in the lower deck of the pallet, once the first and second set of wheels have cleared the first and second planks, the plurality of forks are considered to have fully engaged with the pallet as shown in FIG. 2F. Once the plurality of forks are fully engaged with the pallet, the next operation would be to lift the pallet 18 off the floor as shown in FIG. 2G so that it can be moved on the floor. Lifting the pallet 18 involves lowering or deploying the first set of wheels 10 relative to the plurality of forks by means of the actuation mechanism such that the plurality of forks 4 are raised. Alternatively, the plurality of forks is separately raised causing the first set of wheels 10 to lower so as to engage with the floor. A locking mechanism (not shown) locks the first set of wheels in the lowered or deployed position so as to lift the pallet engaged with the plurality of forks off the floor.

The first set of wheels 10 proximal the distal end of the plurality of forks 4 are load bearing wheels as these wheels bear the weight of the pallet 18 and any loads on the pallet when lifting the pallet off the ground. The second set of wheels 12 proximal to the main body 2 of the pallet mover 1 function as balancing wheels to prevent the pallet mover 1 from tipping when the first set of wheels 10 retract. This allows the first and second sets of wheels 10, 12 to step over one or more planks 24 in the lower deck 22 of the pallet 18 as shown in FIG. 2A-2G. The spacing between the first and second sets of wheels 10, 12 is dependent on the number of planks 24 in the lower deck of the pallet 18 and the number of operations required for the first and second sets of wheels 10, 12 to step over the one or more planks 24 in the lower deck of the pallet when fully engaging with the pallet.

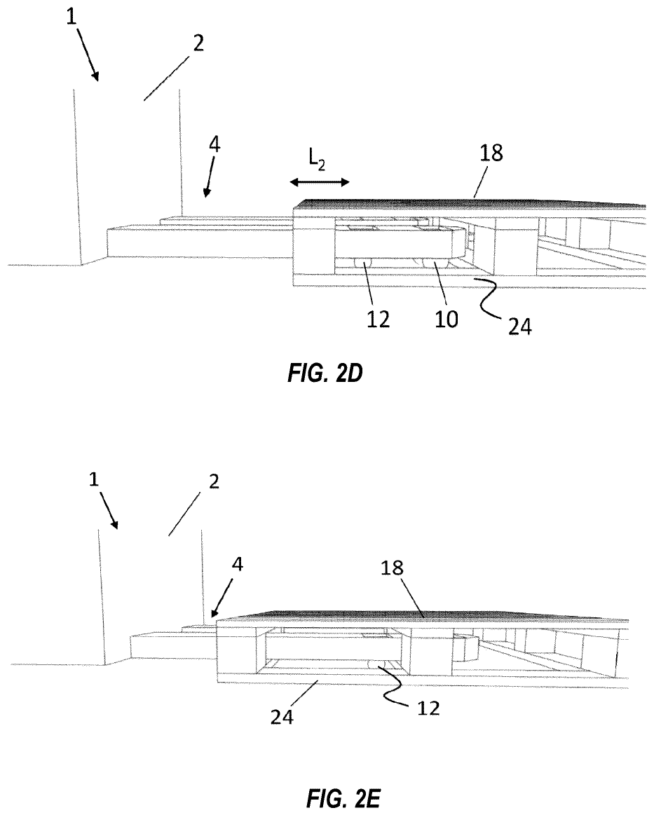

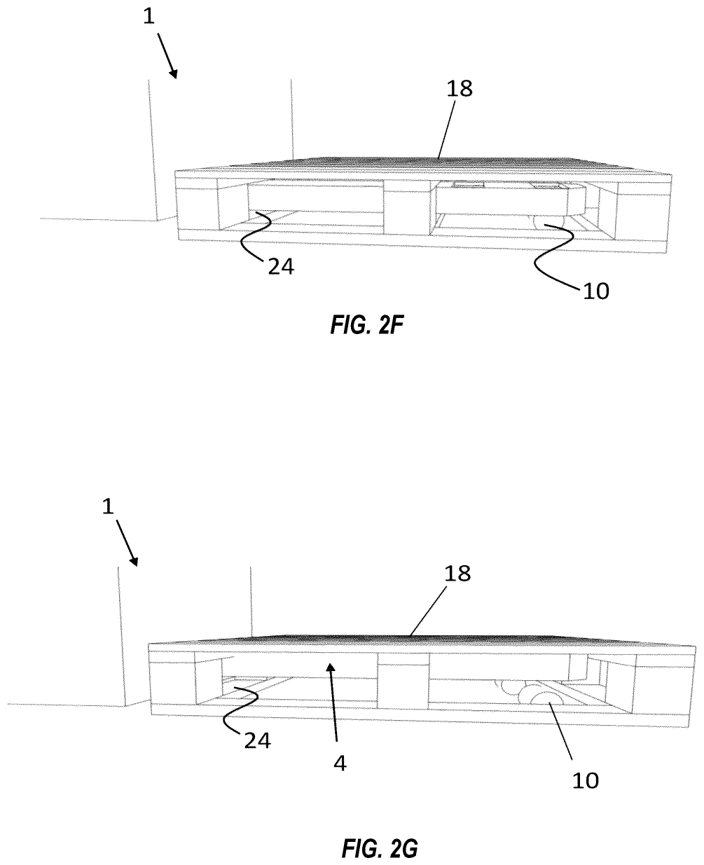

In a second example of the present disclosure shown in FIG. 3, the spacing, S, between the first and second sets of wheels 110, 112 is such that the plurality of forks 104 fully engage with the pallet 18 in a fewer number of operations than in the first example shown in FIG. 1. In comparison to the first example of the present disclosure shown in FIG. 2A-2G requiring multiple movements of the first and second sets of wheels 10, 12 to fully engage with the pallet 18, in the second example of the present disclosure shown in FIG. 3, a single operation is required for the pallet mover 101 to move the first distance L₁ towards the pallet 18 corresponding to the distance the first set of wheels 110 steps over two planks 24 in the lower deck 22 of the pallet 18, i.e. the first distance L₁ corresponds to the spacing between the two planks 24 in the lower deck of the pallet inclusive of the width of the two planks. Thus, the process of fully engaging with the pallet shown in FIG. 4A and FIG. 4B begins with retracting the first set of wheels 110 so that they clear a first plank at the perimeter of the pallet 18 and inserting the plurality of forks into the pallet. Because the spacing between the first and the second sets of wheels is sufficiently large to clear or step over two spaced apart planks in the lower deck of the pallet, the plurality of forks 104 can be inserted further into the pallet so as to step over two planks in the lower deck of the pallet in a single movement operation.

To fully engage with the pallet 18, the first set of wheels 110 deploy and the second set of wheels 112 retract as shown in FIG. 4B so as to allow the pallet mover to move a second distance L₂ closer towards the pallet 18 as shown in FIG. 4C. Once the plurality of forks are fully engaged with the pallet, the plurality of forks 104 can be raised to lift the pallet off the floor. Raising the plurality of forks can involve lowering or deploying the first set of wheels 110. Alternatively, the plurality of forks is independently raised causing the first set of wheels 110 to lower so as to engage with the floor. A locking mechanism (not shown) locks the first set of wheels in the lowered position so as to lift the pallet engaged with the plurality of forks off the floor.

The spacing S between the first and second set of wheels can be varied by varying the position of the first set of wheels 10, 110 relative to the second sets of wheels 12, 112. The closer the second set of wheels 12, 112 is to the main body 2, 102 of the pallet mover 1, 101 without causing the pallet mover to tip when the first set of wheels 10, 110 are retracted, the greater the spacing between the first and second sets of wheels. Typically, the spacing S between first and second sets of wheels has to exceed 100 cm in order for the first set of wheels 110 to step over two planks in the lower deck of the pallet in a single movement operation.

To automate the independent movement of the first and second set of wheels when engaging with the pallet as shown in FIGS. 1 and 3, the pallet mover 1, 101 comprises one or more proximity sensors to sense the presence of nearby obstacles or objects, in this case, the one or more planks in the lower deck of the pallet. Examples of proximity sensors to sense the presence of objects include but is not limited to LiDAR sensors comprising a laser beam source and an optical receiver, ultrasonic sensors. Other examples of sensing the presence of nearby object is use of one or more cameras or depth cameras for visualizing the presence of nearby objects or obstacles. The proximity sensor or camera can be mounted to the plurality of forks, particularly at the distal end of one or more of the plurality of forks. Alternatively, the proximity sensor or the camera can be mounted to the main body of the pallet mover. The control system is coupled to the proximity sensor and/or camera and is configured to independently retract or deploy the first and second sets of wheels in response to one or more signals from the proximity sensor and/or camera.

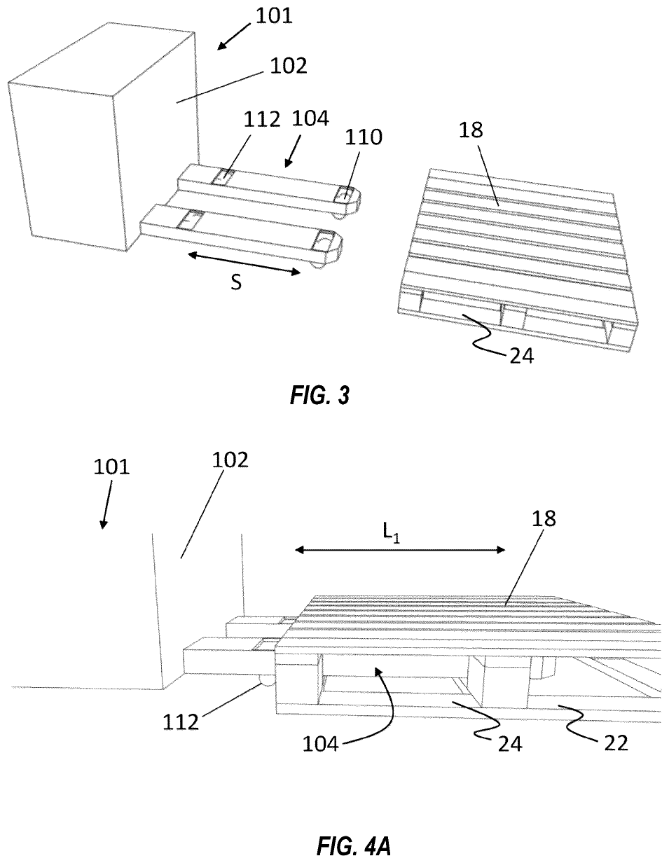

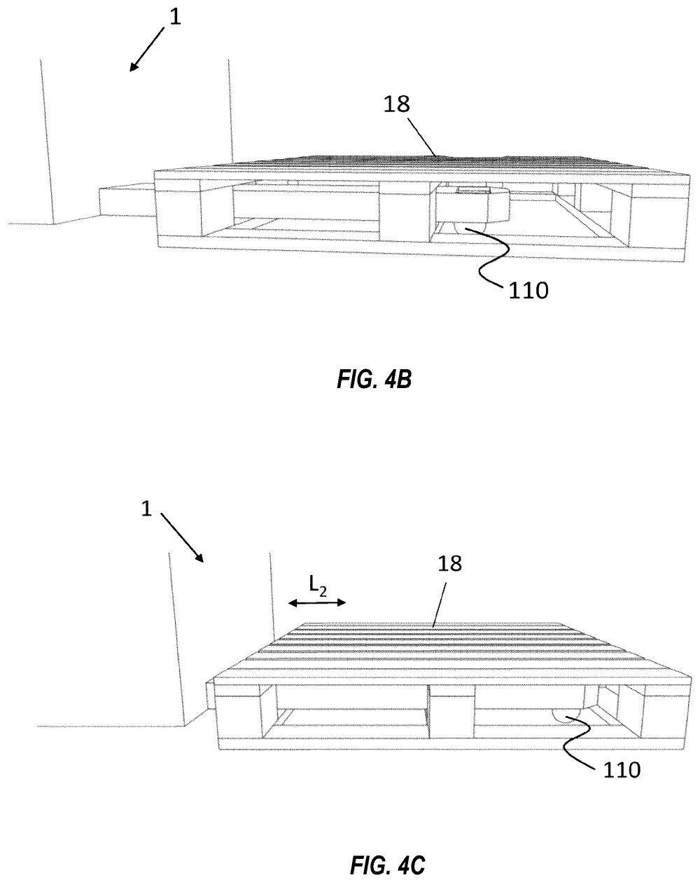

FIG. 5 is a simplified block diagram 30 showing the main components of the pallet mover for engagement with a pallet and FIG. 6 is a flow diagram 50 showing an example of the steps the pallet mover undertakes when engaging with the pallet. The main components of the pallet mover for engagement with a pallet can be summarized in FIG. 5 to comprise an actuation mechanism 38 that is configured to move the first and second set of wheels in a vertical direction, a proximity sensor 44 to senses a nearby object, a drive assembly 40 to maneuver the pallet mover and a fork lifting mechanism 42 to raise and lower the plurality of forks. Each of the components for engagement with a pallet is controlled by a control system 32 comprising a controller 34, e.g. a processor, and a memory storage device 36 for storing instructions to be executed by the controller 34. For example, the instructions include actuating the actuation mechanism 38 to independently move the first and second set wheels in a vertical direction in response to one or more signals from the proximity sensor 44. The steps in the engagement of the plurality of forks with the pallets can be summarized in the flow diagram 50 shown in FIG. 6 in conjunction with FIG. 5. The process begins 52 with the proximity sensor detecting the presence of a plank in the lower deck of the pallet 54. In response to detecting the presence of a plank, the controller 34 actuates the actuation mechanism 38 to retract the first set of wheels and deploy the second set of wheels 56. This allows the pallet mover to move a first distance towards the pallet as the first set of wheels steps over the plank 58. If, however, the pallet mover does not detect the presence of a pallet, the pallet mover is instructed to continue moving 66 until a pallet is detected. To fully engage with the pallet, the controller 34 actuates the actuation mechanism 38 to deploy the first of wheels and retract the second set of wheels so as to allow the second set of wheels to step over the plank when the pallet mover moves a second distance towards the pallet 62.

Depending on the spacing between the first and second sets of wheels, the next stage will determine whether the plurality of forks has fully engaged with the pallet 64. In the case where the spacing between the first and second sets of wheels is relatively small (see FIG. 1) necessitating that the first and second sets of wheels has to step over two planks in two sets of multiple operations or procedures (e.g. four operations) to fully engage with the pallet. After stepping over the first plank of the pallet, the controller 34 in response to one or more signals from the proximity sensor 44 is configured to actuate the actuation mechanism 38 to independently move the first and second sets of wheels to step over a second plank in the lower deck of the pallet. One set of operations or procedures to step over one or more planks in the lower deck of the pallet may involve: retracting the first set of wheels and deploying the second set of wheels; moving the pallet mover a first distance so as to insert a portion of the plurality of forks into the pallet and to step over a first plank in the lower deck of the pallet; deploying the set of wheels and retracting the first set of wheels to stabilize the plurality of forks; and moving the pallet mover a second distance so as to insert an increased portion of the plurality of forks into the pallet;

As the spacing between the first and second sets of wheels is relatively small, the operation above is repeated for stepping over the second plank in the lower deck of the pallet. In the case where the spacing between the first and second sets of wheels is relatively large as shown in FIG. 3, the plurality of forks fully engage with the pallet after stepping over two planks in the lower deck of the pallet in one set of operations (like those listed hereinabove), i.e. movement of the plurality of forks along a first distance and a second distance. When approaching a pallet when the process begins 52, the first and second sets of wheels may already be deployed, in which case the first step may involve retracting the first set of wheels as the second set of wheels is already deployed so as to step over the plank in the lower deck of the pallet. Data associated with the type of plurality of forks which include the spacing between the first and second sets of wheels are stored in the memory storage device 36. The controller in cooperation with the memory storage device is able to determine the type of the plurality of forks when engaging with the pallet.

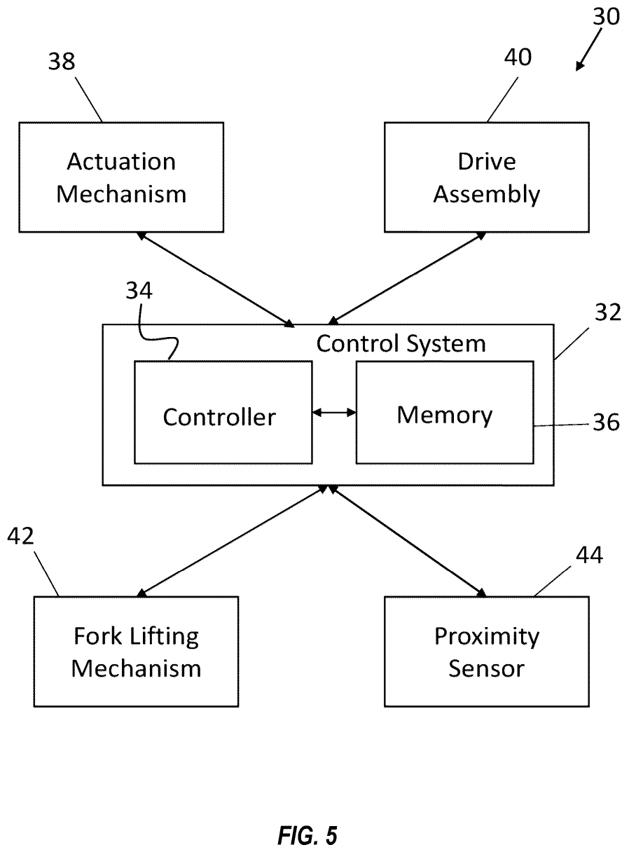

The frequency by which the first and second set of wheels would need to step over the one or more planks in the lower deck of the pallet in order for the plurality of forks to fully engage with the pallet will depend on the separation, S, between the first and second set of wheels along the plurality of forks. The closer the separation, S, between the first and second sets of wheels, the greater the number of times the first and second sets of wheels would need to step over the one or more planks in the lower deck of the pallet. In a second example of the pallet mover 201 shown in FIG. 7A-7E, the second set of wheels 212 can be configured to be retractable longitudinally along the plurality of forks 204 to vary the separation between the first set of wheels 210 and second set of wheels 212 rather than in the substantially vertical direction as in the first example of the present disclosure discussed above with reference to FIGS. 1 to 6. Movement of the second set of wheels 212 along the axis, X-X, as shown in FIG. 7A removes the need to have predetermined separations between the first and the second set of wheels and thus, removes the need for the second sets of wheels 212 to step over the one or more planks in the lower deck 22 of the pallet 18.

To ensure the stability of the pallet mover 201 when the first set of wheels 210 retract, the second set of wheels 212 remain engaged with the floor but retract in a longitudinal direction along the plurality of forks 204 when the second set of wheels 212 approaches the lower deck 22 of the pallet 18. Once inserted into the pallet 18, the lifting mechanism (not shown) is configured to extend or deploy the first set of wheels 210 relative to the plurality of forks 204 in a vertical direction to engage with the floor. Further extension of the first set of wheels 210 relative to the plurality of forks 204 raises the plurality of forks 204 and the pallet supported by the plurality of forks. In the particular example shown in FIG. 7E, the second set of wheels 212 separates from the plurality of forks 204 to maintain the stability of the main body 202 of the pallet mover 201 when the plurality of forks are raised. As shown in FIG. 7A-7E, the second set of wheels 212 are mounted on a plurality of runners 216 that enable the second set of wheels to be retractable in a longitudinal direction parallel to the plurality of forks. The plurality of runners 216 are mounted to the main body 202 of the pallet mover such that when the plurality of forks are raised, the second set of wheels 212 separate from the plurality of forks as shown in FIG. 7E.

Like the first example of the present disclosure, the first and the second sets of wheels 210, 212 can be independently moveable relative to the plurality of forks 204. Independent movement of the first and second sets of wheels can be controlled by an actuating mechanism as discussed above. Movement of the second set of wheels 212 in a longitudinal direction from a forward position as shown in FIG. 7B to a rearward position as shown in FIG. 7D occurs when the second set of wheels approaches the lower deck 22 of the pallet 18. Various means can be used to move the second set of wheels 212 in the longitudinal (substantially horizontal direction) direction along the plurality of forks 204. One example, is the second set of wheels 212 can be resiliently biased in the forward direction by a resilient member (e.g. spring) such that they are closer to the first set of wheels 210 in a resting position providing increased stability of the pallet mover 201 when the first set of wheels is in the retracted configuration vertically within the plurality of forks 204. The resilient member (not shown) is configured to retract the second set of wheels 212 in a longitudinal direction away from the first set of wheels when the bias of the resilient member is overcome. For example, the resiliency of the resilient member can be chosen such that the bias of the resilient member is overcome by the drive assembly (e.g. a motor) of the pallet mover. The second set of wheels 212 is arranged to butt up against the lower deck 22 of the pallet 18 when the plurality of forks 204 are initially inserted into the pallet (see FIG. 7C). The bias is overcome by virtue of the drive assembly moving the pallet 18 and the plurality of forks engaging with the pallet. In the particular example shown in FIG. 7A-7E, the drive assembly comprises a drive wheel 214 rotatable about a drive axis for driving movement of the pallet mover on the floor. The mere driving action of the pallet mover towards the pallet may be sufficient to overcome the bias of the second set of wheels to retract away from the first set of wheels as the plurality of forks progressively engages with the pallet (see FIG. 7D).

Instead of the second set of wheels butting up against the lower deck of the pallet, each wheel of the second set of wheels can be mounted to a cradle that is moveable in a longitudinal direction along its respective fork and is arranged to butt up against the lower deck when the plurality of forks enters the pallet. The use of a cradle to carry each of the second set of wheels mitigate the risk of the second set of wheels riding over the one or more of the planks in the lower deck of the pallet when the plurality of forks enters into the pallet. Alternatively, a drive mechanism in response from a signal from a suitable sensor (e.g. proximity sensor) can be configured to progressively retract the second set of wheels as the plurality of forks increasingly engage with the pallet. In all cases, the first set of wheels remain retracted until the plurality of forks are fully engaged with the pallet.

The steps of engagement of the plurality of forks of the pallet mover 201 according to the second example of the present disclosure with a pallet 18 can now be described with reference to FIG. 7A-7E. The position of the first 210 and second 212 sets of wheels relative to the plurality of forks 204 in a normal configuration is shown in FIG. 7A and shows the first set of wheels 210 in the retracted position and the second set of wheels 212 in the forward position relative to the plurality of forks to maintain the stability of the pallet mover as the pallet mover moves on the floor. The second set of the wheels 212 is shown mounted to a cradle that is moveable in a longitudinal or axial direction, X-X. Also shown is the drive wheel 214 mounted to the main body 202 of the pallet mover 201 for moving the pallet mover. The second set of wheels 212 approaches the lower deck 22 of the pallet 18 as the plurality of forks 204 enters the pallet as shown in FIG. 7B. Further movement of the pallet mover 201 towards the pallet not only increases the proportion of the plurality of forks entering the pallet but causes the second set of wheels 212 to butt up against the lower deck 22 of the pallet 18, more specifically, a plank in the lower deck of the pallet as shown in FIG. 7C. This causes the second set of the wheels 212 to retract in a rearward direction away from the first set of wheels 210 as the plurality of forks are driven into the pallet as shown in FIG. 7D. Once the plurality of forks have fully engaged with the pallet as shown in FIG. 7E, the lifting mechanism is actuated to extend the first set of wheels 210 in a vertical direction to engage with the floor to stabilize the pallet mover on the floor as the plurality of forks are raised. Further extension or lowering of the first set of wheels raises the plurality of forks, which in turn raises the pallet off the floor. Like the first example of the pallet mover, the lifting mechanism can comprise a hydraulic pump and/or electric motor which is coupled to the first sets of wheels by one or more levers to raise or lower the plurality of forks.

Whilst the move towards autonomously controlling the movement of the pallet mover increases the efficiency of moving pallets around a warehouse, there are still occasions where manual intervention is required to move the pallet mover. In simple terms, there may be occasions where the control system autonomously controlling the movement of the pallet mover would need to be manually overridden to control the movement of the pallet mover. Occasions where the control of the pallet mover would need to be manually overridden include but are not limited to negotiating a tight corner or obstacle, freeing up a pallet mover that is stuck or simply making effective use of the floor space in a warehouse where 100% autonomous control does not provide an effective way to move the pallet around the warehouse. Typically, an AGV pallet mover may need specialized surfaces or flooring including built in sensors or markings on the floor to negotiate around obstacles. However, such specialized surfaces are not always present, for example, in an inbound area of the warehouse, where stock or goods arriving on pallets on the back of trailers or trucks would need be transported into the warehouse and subsequently to their final destination. Usually, such trailers are tightly spaced areas requiring the pallet mover to negotiate tight spaces in order to properly engage the plurality of forks with a pallet in the trailer. Secondly, there may not be adequate markings or sensors in the trailer to autonomously control the movement of the pallet mover, i.e. the pallet mover may lose signal carrying instructions from a central controller to autonomously control the movement of the pallet mover.

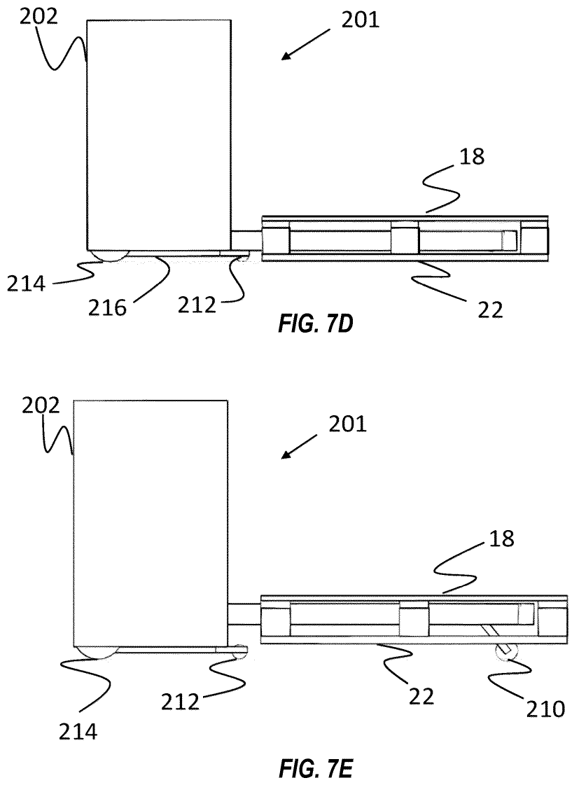

To overcome this problem, the pallet mover 301 according to the present disclosure can be semi-autonomous having an autonomous mode and a manual mode. In the autonomous mode, the control system 32 receives signals comprising instructions to control the movement of the pallet mover 301 in the warehouse. In the example shown in FIG. 10, autonomous control of the pallet mover is shown moving pallets carrying goods arriving in the back of trailers 322 in the inbound area of a warehouse 300. As shown in FIG. 10, the manual mode of operation of the pallet mover 301 may be required when unloading goods arriving on a plurality of pallets on the back of a trailer 322. For the purpose of definition of the present disclosure, the “manual mode” of operation of the pallet mover covers the operation where the operator manually controls the movement of the pallet mover 301. This includes but is not limited to taking control over the drive assembly and the steering mechanism to move and steer the pallet mover on the floor, manually controlling the first and second sets of wheels to step over one or more planks in the lower deck of the pallet 18, and/or manually controlling the lifting mechanism to raise and lower the plurality of forks. Once unloaded from the trailer 322, the pallet mover 301 carrying the pallet 18 can be switched from the manual mode to the autonomous mode so that the movement of the pallet mover around the warehouse and subsequently to its final destination can be autonomously controlled.

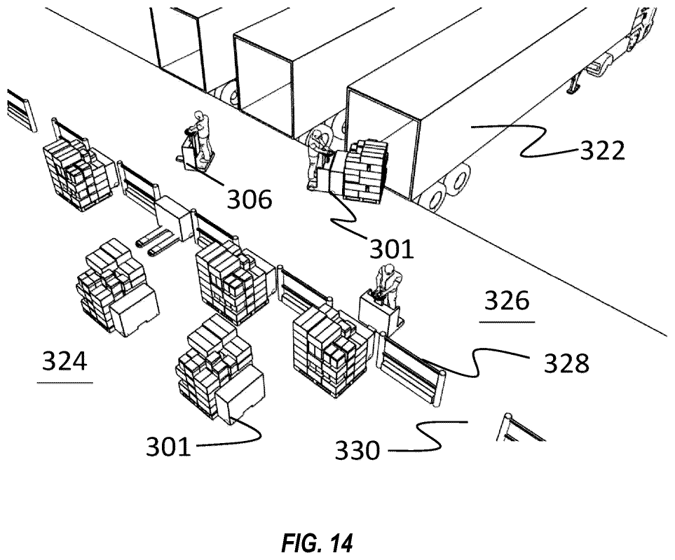

The warehouse can be divided into a plurality of zones or regions. The plurality of zones or regions can comprise an autonomous zone for allowing the pallet mover to operate in the autonomous mode and a manual zone for allowing the pallet mover to operate in the manual mode. The autonomous zone can be demarcated from the manual zone by a barrier or any suitable divider. Examples of a demarcation between the manual zone and the autonomous zone include but is not limited to a physical barrier having one or more apertures 330 for the pallet mover to transition between the autonomous zone and the manual zone or an invisible barrier such as a light barrier. Other examples include the warehouse comprising a wireless region covering the autonomous zone such that the pallet mover is able to receive signals carrying instructions from a central controller to operate in the autonomous mode, i.e. the range of the wireless region extends to the edge of the autonomous zone. Beyond the autonomous region, the pallet mover is out of range of the wireless region and therefore, unable to receive signals from the central controller, in which case the pallet mover switches to the manual mode of operation. In the particular example shown in FIGS. 10 and 14, the autonomous zone 324 is separated from the manual zone 326 by a physical barrier 328 comprising the one or more apertures 330. When in the autonomous zone 324, the pallet mover automatically switches or transitions to the autonomous mode. Likewise, the pallet mover switches to the manual mode of operation when in the manual zone. Transition to the manual mode can automatically occur when the pallet mover is in the manual zone 326 of the warehouse. Dividing the warehouse into a plurality of zones and the operation of the pallet mover is dependent on whether the pallet mover is in the manual zone or the autonomous zone prevents an operator from trying to transition the pallet mover into the manual mode of operation when in the autonomous zone of the warehouse and vice versa. Alternatively, there can an overlap between the manual zone 326 and the autonomous zone 324. It should be understood that in an alternative configuration the manual zone and the autonomous zone may be contiguous.

To convert the pallet mover 301 from the autonomous mode to the manual mode, the pallet mover 301 according to a third example of the present disclosure comprises a user manual interface 306 having an interface portion 308 that is configured to couple with the steering mechanism and the drive assembly comprising the drive wheel 314 of the pallet mover 301 to control the direction and movement of the pallet mover 301. The interface portion 308 can be configured to electrically couple with the steering mechanism and the drive assembly to manually control the movement of the pallet mover. Signals generated by the user manual interface 306 are fed to the steering mechanism and the drive assembly (comprising the drive wheel 314) via the interface portion 308 and the control system 32 to control the movement of the pallet mover 301. The interface portion 304 include but is not limited to a physical contact between the user manual interface 306, e.g. electrical contact pads, and the main body 302 of the pallet mover 301 but can also include a short range wireless link between the manual user interface and the pallet mover, e.g. Bluetooth. The wireless link is established when the manual user interface establishes a contact with the main body of the pallet mover. The pallet mover 301 can comprise one or more sensors configured to sense the presence of the user manual interface 306 when coupled to the main body 302 of the pallet mover. Such sensors include various coupling sensors including but are not limited to proximity sensors, mechanical switches, etc. The coupling sensor is coupled to the control system of the pallet mover which processes the signal from the coupling sensor to switch operation of the pallet mover between the autonomous mode and the manual mode in response from one or more signals of the coupling sensor. For example, once the coupling sensor senses that the user manual interface 306 is coupled to the main body of the pallet mover, a signal is sent to the control system 32 which processes the signal to switch operation of the pallet mover from the autonomous mode to the manual mode allowing it to be controlled by the user manual interface 306.

In operation, an operator can move the pallet mover 301 to the edge of the autonomous zone and cause the user manual interface to disengage from the pallet mover. The pallet mover can then perform one or more autonomous actions. For example, the central controller may communicate a location in the autonomous zone to the pallet mover. The pallet mover will then move autonomously to this location. The location may be adjacent to one of a plurality of stations which are located within the autonomous zone. The stations may be decant stations which are used to decant product items from the pallets such that they can be inducted into an automated storage and retrieval system. This decant function may be performed by human operators, by robotic picking arms, or by a combination of the two. Once all of the product items have been removed from the pallet then the pallet mover may deposit the empty pallet at a pallet storage location. Once the pallet mover has disposed of the pallet then it may return to the manual zone so that the pallet mover can be attached to a further user manual interface in order to complete a further task.

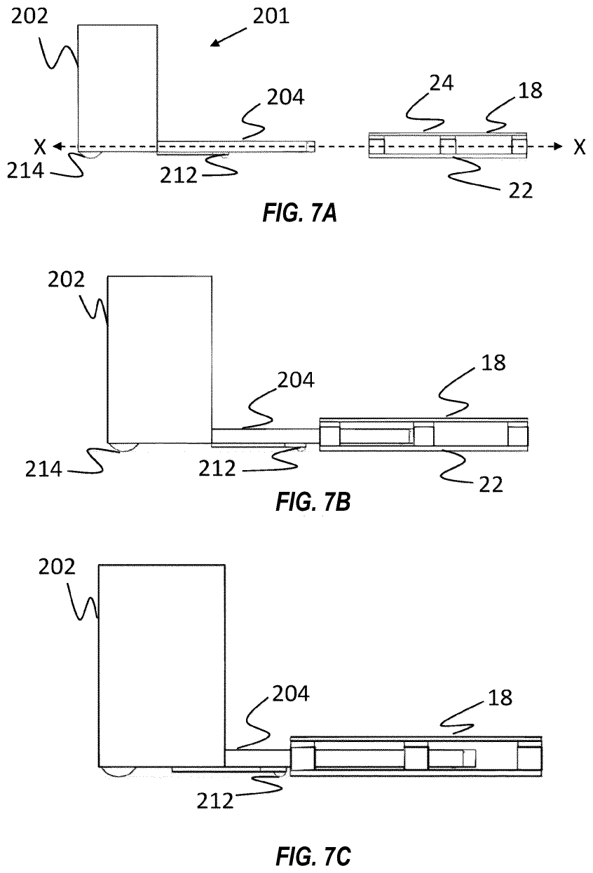

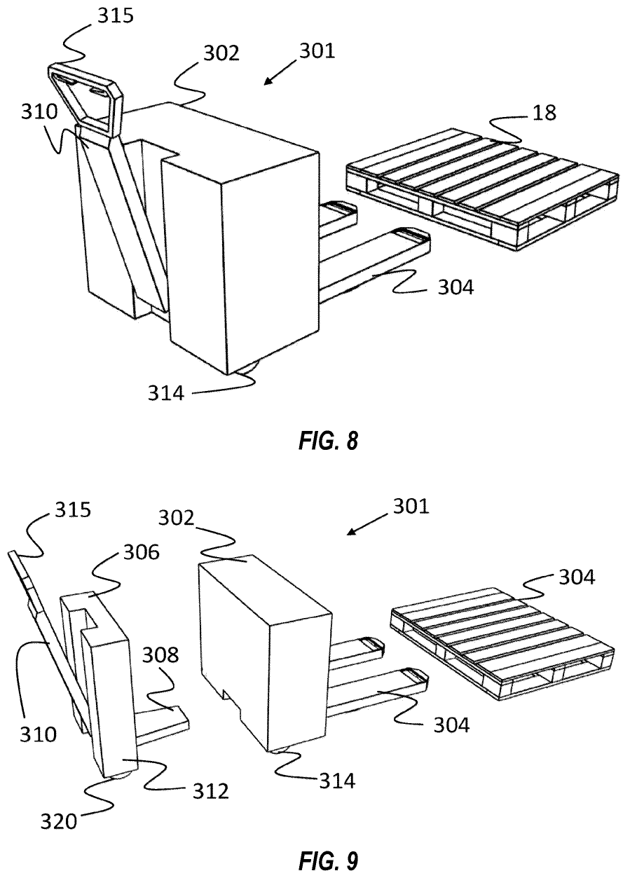

In the particular example of the present disclosure shown in FIGS. 9 and 11, the user manual interface 306 comprises a manual steering mechanism 310 that is coupled to the steering mechanism of the pallet mover such that the user manual interface can override the control system 32 to manually control the direction of movement of the pallet mover. Equally plausible in the present disclosure is that the user manual interface 306 can override the control system 32 to independently control movement of the first and second sets of wheels to step over one or more planks in the lower deck of the pallet discussed above. For example, the user manual interface can comprise a switching mechanism (e.g. one or more physical switches) to independently control retraction and deployment of the first and second sets of wheels in the substantially vertical direction to step over one or more planks in the lower deck of the pallet. In addition to or alternatively to manually controlling the steering mechanism via the control system 32 of the pallet mover, the user manual interface can have its own control system (not shown) that operates independently of the control system 32 of the pallet mover 301 to control the movement of the pallet mover. For example, the control system of the manual user interface can override the control system of the pallet mover to control the drive assembly and/or the steering mechanism and/or the operation of the first and second set of wheels. In other words, the user manual interface can be carried by the main body of the pallet mover 301. In addition to or alternatively to manually controlling the pallet mover via the drive assembly and/or the steering mechanism of the pallet mover, the user manual interface can comprise its own independent manual steering mechanism and/or manual drive mechanism comprising a drive wheel to move the pallet mover. The manual steering mechanism and/or the manual drive mechanism can simply be a push and pull system where the operator physically pushes or pulls the user manual interface via the manual steering mechanism and/or the manual drive mechanism to move the pallet mover.

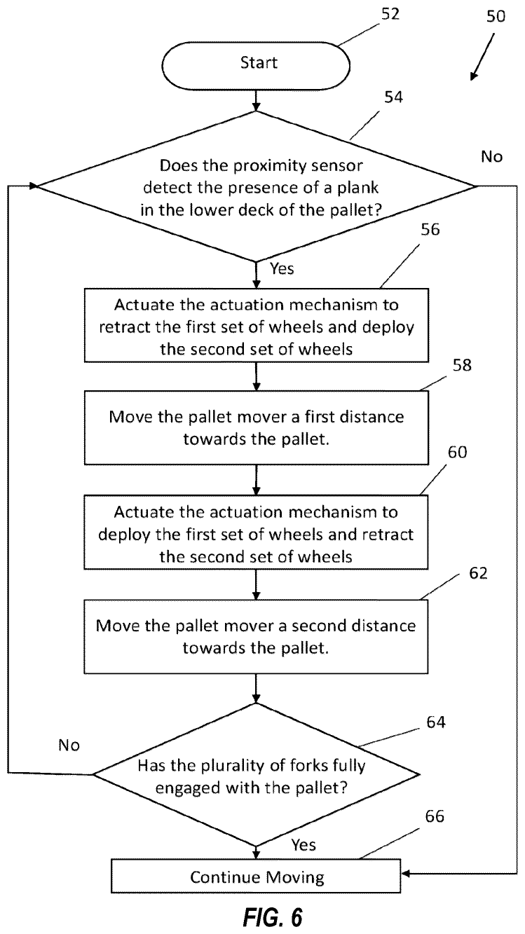

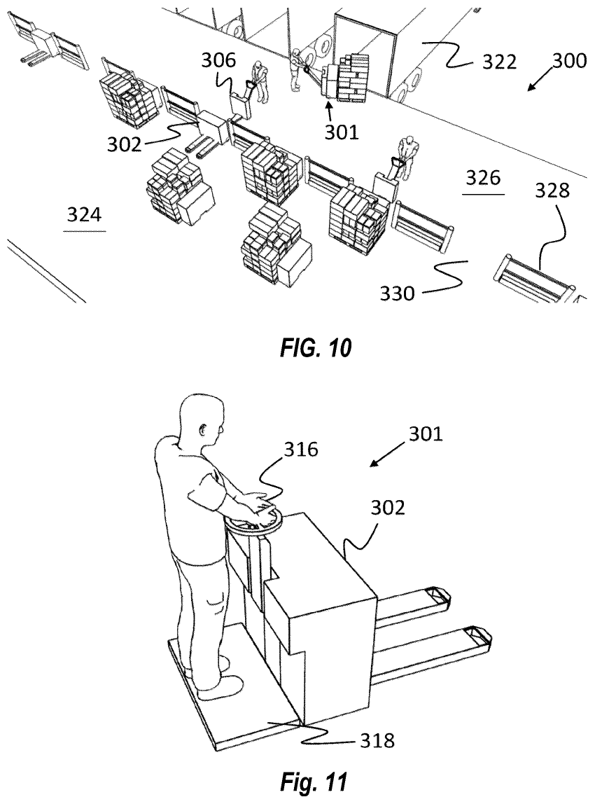

The manual steering mechanism 310 is shown in FIG. 8 comprising a tiller arm 315 to be maneuvered by an operator for adjusting the direction of travel of the pallet mover 301. The tiller arm 315 is coupled to the drive wheel 314 and the steering mechanism of the pallet mover such that movement of the tiller arm 315 controls the movement of the pallet mover on the floor. Alternatively to manually controlling the direction of travel of the pallet mover by the tiller arm 315, the manual steering mechanism 310 can comprise a steering wheel 316 as shown in FIG. 11. Like the tiller arm, the direction of travel of the pallet mover is manually controlled by the rotation of the steering wheel 316. The user manual interface 306 can be a permanent fixture of or is integrated into the main body 302 of the pallet mover or is detachable from the pallet mover. In the example shown in FIG. 11, the pallet mover 301 comprises a platform 318 for an operator to stand whilst manually maneuvering the pallet mover via the in-built manual steering mechanism 310, which can comprise the steering wheel 316. The platform 318 can be rotatably mounted to the main body 302 of the pallet mover 301 and moveable from a deployed position for an operator to stand and a stowed position such that platform is folded up against the main body 302 of the pallet mover as shown in FIG. 12. In the particular example shown in FIG. 12, the platform 318 is pivotally mounted to the main body of the pallet mover by a suitable hinge (not shown). The hinge can comprise a torsion biasing assembly, e.g. coiled spring, to bias the platform in the stowed position. The main body of the platform can comprise one or more sensors, e.g. door sensors, which are actuated when the platform is in the stowed position. In response to actuation of the one or more door sensors, the control system switches the pallet mover from the manual mode to the autonomous mode. The advantage of integrating the user manual interface into the main body 302 of the pallet mover 301 is the flexibility by which an operator can switch operation of the pallet mover from the autonomous mode to the manual mode simply by moving the platform to the deployed position and/or operating the user manual device. However, one of the main drawbacks of integrating the user manual interface with the pallet mover is the need to carry an additional weight of the user manual interface when operating in the autonomous mode.

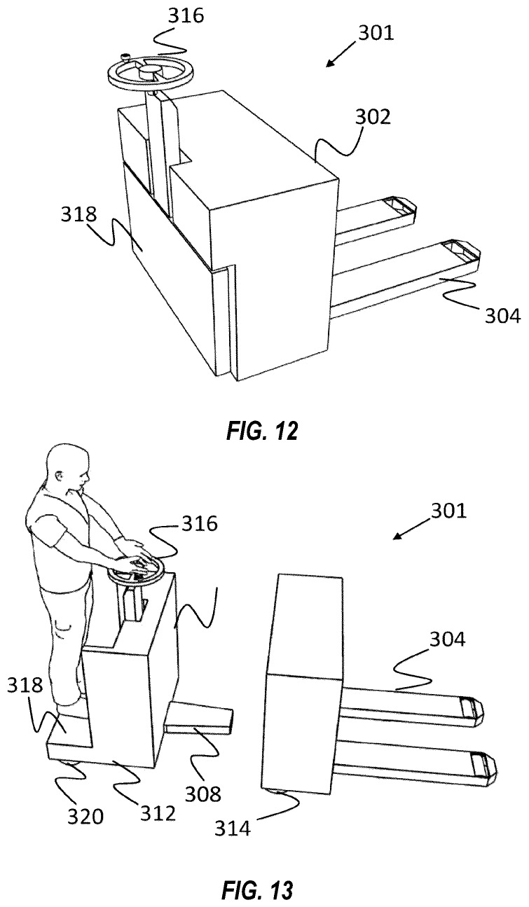

In another aspect of the present disclosure, the user manual interface 306 is detachable or removably coupled to the main body 302 of the pallet mover as exemplified in FIG. 9 and FIG. 13. In the examples shown in FIGS. 9 and 13, the user manual interface 306 can be a separate standalone device comprising a body 312 and a wheel assembly 320 supporting the body 312 for moving the user manual interface independently of the pallet mover 301, i.e. a system comprising the user manual interface 306 and the pallet mover 301 of the present disclosure. This allows an operator to separate the user manual interface from the main body of the pallet mover when converting the pallet mover to the autonomous mode. When coupled to the main body of the pallet mover, the manual steering mechanism 310 can take over control of the drive assembly and/or the steering mechanism of the pallet mover. This could be via the control system 32 of the pallet mover or a separate control system built into the user manual interface, i.e. the separate control system can override the control system 32 of the pallet mover to manually control the movement of the pallet mover via the manual steering mechanism. To enable the user manual interface to detach and recouple with the pallet mover, the user manual interface can comprise the manual drive mechanism coupled to the wheel assembly 320 of the user manual interface 306. As exemplified in FIGS. 9 and 13, the steering mechanism can be a tiller arm 315 or a steering wheel 316. One or more coupling sensors discussed above mounted to the body 312 of the user manual interface 306 and/or the main body 302 of the pallet mover 301 senses the presence of the user manual interface 306 when coupled to the main body 302 of the pallet mover 301. In the particular, as in the example shown in FIG. 13, the detachable user manual interface 306 comprises an integrated platform or ride on platform 318 for an operator to stand and maneuver the user manual interface using the manual steering mechanism.

In operation, e.g. when unloading a trailer 322 as shown in FIGS. 10 and 14, an operator can couple the user manual interface 306 with the main body 302 of the pallet mover 301. The operator can then manually control the movement of the pallet mover including the movement of the first and second sets of wheels by the user manual interface. Once at a target pallet, the operator can engage the plurality of forks with the target pallet by manually operating the first and/or second sets of wheels to step over one or more planks in the lower deck of the pallet as discussed above with respect to the first and second example of the present disclosure. Once engaged with the pallet, the operator can manually operate the lifting mechanism to lift the pallet off the floor. The lifting mechanism can involve extending the first set of wheels such that the plurality of forks are raised above the floor. However, other means to manually raise the plurality of forks are permissible in the present disclosure, e.g. a hydraulic pump and/or electric motor which is coupled to the first and/or second sets of wheels by one or more levers to raise or lower the plurality of forks.

Once engaged with the pallet, the operator can manually maneuver the pallet mover via the user manual interface to a destination where the pallet mover can operate in the autonomous mode. The operator can subsequently decouple the user manual interface from the main body 302 of the pallet mover as shown in FIGS. 10 and 14 to enable the pallet mover to operate in the autonomous mode. Decoupling the user manual device from the pallet mover involves detaching the user manual interface 306 from the main body 302 of the pallet mover 301. The pallet mover switches to autonomous mode when one or more of the coupling sensors recognizes that the user manual interface is not coupled to the main body of the pallet mover.

In all examples of the pallet mover described with reference to FIGS. 8 to 14, the pallet mover may comprise an actuator to switch between the manual mode and the autonomous mode of operation in response to one or more signals from the coupling sensors. Examples of actuators include but are not limited to various switches,

It will be understood that various changes, modification, alterations, and combination in the details, materials and arrangements of the parts and components that have been described and illustrated in order to explain the pallet mover as described herein may be made by those skilled in the art within the principle and scope of this disclosure.

What is claimed is:

1. A pallet mover for moving a pallet, wherein:
the pallet comprises:
a top deck formed from one or more first planks; and
a lower deck formed from one or more second planks, the lower deck being spaced apart from the top deck, and the pallet mover comprises:
a main body comprising a lifting mechanism and a drive assembly for moving the pallet mover;
a plurality of forks for lifting and handling pallets, the plurality of forks outwardly extending from the main body and configured to be lifted by the lifting mechanism; and
a first set of wheels and a second set of wheels, each of the first set of wheels and second set of wheels being independently moveable relative to the plurality of forks, the first set of wheels being configured to be moveable in a vertical direction between a retracted position to disengage from a floor and a deployed position to engage with the floor such that, in use, the first set of wheels are configured to step over the one or more second planks of the pallet when the plurality of forks are inserted into the pallet.

2. The pallet mover of claim 1, wherein the lifting mechanism is configured to lift the plurality of forks by extending the first set of wheels when in the deployed position in the vertical direction relative to the plurality of forks.

3. The pallet mover of claim 1, wherein the second set of wheels is configured to be moveable in a vertical direction relative to the plurality of forks between a deployed position to engage with the floor and a retracted position to disengage from the floor.

4. The pallet mover of claim 3, wherein each wheel of the first set of wheels and/or second set of wheels is moveable in the vertical direction by being pivotally mounted to the plurality of forks.

5. The pallet mover of claim 3, further comprising a locking mechanism configured to lock the first set of wheels or second set of wheels in the retracted or deployed position.

6. The pallet mover of claim 1, wherein the second set of wheels engages with the floor and is configured to be retractable in a longitudinal direction along the plurality of forks between a forward position and a retracted position, the forward position being closer to the first set of wheels than the retracted position.

7. The pallet mover of claim 1, further comprising an actuation mechanism operable to independently move the first set of wheels and/or the second set of wheels relative to the plurality of forks.

8. The pallet mover of claim 7, further comprising a control system configured to actuate the actuation mechanism to independently move the first set of wheels and/or the second set of wheels relative to the plurality of forks.

9. The pallet mover of claim 8, wherein the pallet mover is an autonomous pallet mover comprising a location recognition sensor for detecting a location of the pallet mover in a travelling direction, said control system being configured to move the pallet mover in response to one or more signals from the location recognition sensor.

10. The pallet mover of claim 8, further comprising a proximity sensor for detecting an obstacle, said proximity sensor being in cooperation with the actuation mechanism such that, in use, the actuation mechanism is configured to actuate movement of the first set of wheels or second set of wheels in the relative to the plurality of forks in response to a signal from the proximity sensor.

11. The pallet mover of claim 1, wherein the first set of wheels is proximal to a distal end of the plurality of forks and the second set of wheels is proximal to the main body of the pallet mover.

12. The pallet mover of claim 1, wherein the drive assembly comprises a drive wheel rotatable about a drive axis and a drive mechanism for driving the drive wheel about the drive axis.

13. The pallet mover of claim 1, further comprising a steering mechanism for changing direction of the pallet mover.

14. The pallet mover of claim 12, wherein the steering mechanism is coupled to the drive wheel and being configured for rotating the drive wheel about a steering axis that is substantially perpendicular to the drive axis of the drive wheel.

15. The pallet mover of claim 13, further comprising a user manual device having an interface portion that is configured to couple with the steering mechanism and the drive assembly to manually control the direction and movement of the pallet mover.

16. The pallet mover of claim 15, wherein the user manual device comprises a body and a wheel assembly for moving the body.

17. The pallet mover of claim 16, wherein the user manual device comprise a manual steering mechanism coupled to the wheel assembly for steering the body of the user manual device.

18. A method of moving a pallet by a pallet mover, wherein:
the pallet comprises:
a top deck formed from one or more first planks; and
a lower deck formed from one or more second planks, the lower deck being spaced apart from the top deck, and the pallet mover comprises:
a main body comprising a lifting mechanism and a drive assembly for moving the pallet mover;
a plurality of forks for lifting and handling pallets, the plurality of forks outwardly extending from the main body and configured to be lifted by the lifting mechanism; and
a first set of wheels and a second set of wheels, each of the first set of wheels and second set of wheels being independently moveable relative to the plurality of forks, the first set of wheels being configured to be moveable in a vertical direction between a retracted position to disengage from a floor and a deployed position to engage with the floor such that, in use, the first set of wheels are configured to step over the one or more second planks of the pallet when the plurality of forks are inserted into the pallet, and the method comprises:
independently moving the first set of wheels in a vertical direction so as to step over one or more planks in the lower deck of the pallet when the plurality of forks are inserted into the pallet; and
independently moving the second sets of wheels in a vertical direction so as to step over one or more planks in the lower deck of the pallet when the plurality of forks are inserted into the pallet.

19. The method of claim 18, wherein the first and second sets of wheels steps over the one or more planks in the lower deck of the pallet by the steps of:
retracting the first set of wheels so as to disengage the first set of wheels from the floor;
moving the pallet mover a first distance towards the pallet so that at least a portion of the plurality of the forks enters the pallet;
deploying the first set of wheels so as to engage the first set of wheels with the floor;
retracting the second set of wheels so as to disengage the second set of wheels from the floor; and
moving the pallet mover a second distance towards the pallet so that a second, further portion of the plurality of the forks enters the pallet.

20. A method of moving a pallet by a pallet mover, wherein:
the pallet comprises:
a top deck formed from one or more first planks; and
a lower deck formed from one or more second planks, the lower deck being spaced apart from the top deck, and
the pallet mover comprises:
a main body comprising a lifting mechanism and a drive assembly for moving the pallet mover;
a plurality of forks for lifting and handling pallets, the plurality of forks outwardly extending from the main body and configured to be lifted by the lifting mechanism;
a first set of wheels and a second set of wheels, each of the first set of wheels and second set of wheels being independently moveable relative to the plurality of forks, the first set of wheels being configured to be moveable in a vertical direction between a retracted position to disengage from floor and a deployed position to engage with the floor such that, in use, the first set of wheels are configured to step over the one or more second planks of the pallet when the plurality of forks are inserted into the pallet; and
the second set of wheels engages with the floor and is configured to be retractable in a longitudinal direction along the plurality of forks between a forward position and a retracted position, the forward position being closer to the first set of wheels than the retracted position, and
the method comprises:
moving the pallet mover a first distance towards the pallet so that a first portion of the plurality of the forks enters the pallet;
retracting the second set of wheels in a longitudinal direction along the plurality of forks relative to the plurality of forks; and
moving the pallet mover a second distance towards the pallet so that a second, further portion of the plurality of the forks enters the pallet.

21. The method of claim 18, further comprising the step of raising the plurality of forks by extending the first set of wheels in a substantially vertical direction.
